(19) United States
(12) Patent Application Publication
(10) Pub. No.: US 2024/0003628 A1
(43) Pub. Date: Jan. 4, 2024

(54) CENTERING DEVICE FOR METAL BLANKS

(71) Applicant: EBNER Industrieofenbau GmbH, Leonding (AT)

(72) Inventors: Robert EBNER, Leonding (AT); Harald HUMER, Traun (AT); Anton OPPERMANN, Steyr (AT); Daniel SCHATZ, Asten (AT)

(73) Assignee: EBNER Industrieofenbau GmbH, Leonding (AT)

(21) Appl. No.: 18/035,350

(22) PCT Filed: Nov. 8, 2021
(86) PCT No.: PCT/AT2021/060413

§ 371 Date: May 4, 2023

(30) Foreign Application Priority Data
Nov. 9, 2020 (DE) 10 2020 129 506.5

(51) Int. Cl. F27B 9/24; C21D 9/00; C21D 11/00; C21D 1/673; F27D 3/00

(52) U.S. Cl. CPC F27B 9/2407; C21D 9/0018; C21D 9/0012; C21D 11/00; C21D 9/0056; C21D 1/673; F27D 3/00; F27D 2003/0046

(57) ABSTRACT

A device for aligning a metal blank for a temperature control system which has at least one temperature control unit for heating or cooling the metal blank includes at least two support rollers on which the metal blank can be placed and conveyed through the temperature control system by rotation of the support rollers in the throughput direction and within a conveying plane. The support rollers are arranged spaced apart in the throughput direction. The device further includes a first centering unit having at least one centering finger which is movably arranged within the conveying plane such that the centering finger is movable transversely to the throughput direction in order to align the metal blank in a predetermined orientation.

### TECHNICAL FIELD

The present invention relates to a device for aligning a metal blank for a temperature control system and to the temperature control system for controlling the temperature of a metal blank. Furthermore, the present invention relates to a method for aligning a metal blank for a temperature control system.

### BACKGROUND OF THE INVENTION

Flat metal components, such as flat steel and/or metal blanks, are heated or cooled to desired temperatures in temperature control devices. Temperature control devices may also include forming devices, such as rolling devices or press hardening devices.

In modern temperature control devices, metal blanks are subjected in particular to a predetermined temperature profile such that the temperature of specific areas of the metal blank is controlled differently from other areas of the metal blank. In this way, desired material properties, such as hardness or ductility, can be specifically set in certain areas of the metal blank. Due to positioning tolerances of the metal blank in the temperature control devices, deviations from the specified temperature control profile may occur.

### DESCRIPTION OF THE INVENTION

It is an object of the present invention to precisely align a metal blank in a temperature control device of a temperature control system in order to apply a desired temperature profile to the metal blank.

This object is achieved by a device for aligning a metal blank for a temperature control system, the temperature control system for controlling the temperature of the metal blank, and a method for aligning a metal blank for a temperature control system according to the subject matters of the independent claims.

According to a first aspect of the present invention, a device for aligning a metal blank (and/or a metal plate) for a temperature control system, which may comprise at least one temperature control unit for heating or cooling the metal blank, is described. The device comprises at least two support rollers on which the metal blank can be placed and conveyed through the temperature control system by rotation of the support rollers in the throughput direction and within a conveying plane, wherein the support rollers are arranged being spaced apart in the throughput direction. Furthermore, the device comprises a first centering unit having at least one centering finger which is movably arranged within the conveying plane such that the centering finger is movable transversely to the throughput direction in order to align the metal blank in a predetermined orientation.

According to a further aspect of the present invention, a temperature control system for temperature control of a metal blank, which may comprise at least one temperature control unit for heating or cooling the metal blank, is described. The temperature control system comprises at least one temperature control unit and a device for aligning a metal blank described above, wherein the device is arranged in front of the temperature control unit in the throughput direction in such a way that the metal blank may be aligned in front of or at least partially in the temperature control unit.

According to a further aspect of the present invention, a method of aligning a metal blank for a temperature control system is described. According to the method, the metal blank is conveyed within a conveying plane through the temperature control system by means of at least two support rollers on which the metal blank rests and is conveyed by means of rotation of the support rollers (i.e., with at least one driven support roller) in the throughput direction. The support rollers are spaced apart in the throughput direction. Furthermore, the metal blank is aligned in a predetermined orientation by means of a first centering unit having at least one centering finger, which is movably arranged within the conveying plane such that the centering finger is movable transversely to the throughput direction in order to align the metal blank.

The metal blank is in particular a flat product (flat steel, metal plate) and accordingly substantially wider than thick. The metal blank may represent a singular component of the same type. For example, the metal blank may be made of steel and/or non-ferrous metals. In particular, the metal blank may be made of aluminum. The metal blank may, for example, have a homogeneous rectangular, round or elliptical shape. In practice, however, metal blanks often have complex shapes. For example, metal blanks form corresponding stamped or otherwise cut metal plates that have complex outlines. In this regard, it is desirable for the temperature of different areas of the metal blank to be controlled differently in a temperature control unit.

The temperature control system has one or more temperature control units which are arranged, for example, one after the other in the throughput direction. The temperature control units may, for example, heat or specifically cool the metal blank. In this regard, the metal blank may be conveyed continuously through a temperature control unit or placed sequentially at predetermined positions within the temperature control units and subjected to stationary heat treatment before further transport along the throughput direction is performed. In this regard, the temperature control units may heat or cool specific areas of the metal blank differently. Thus, a predetermined heat pattern or cooling pattern may be applied to the metal blank, provided that the metal blanks are aligned in a predetermined orientation. In an exemplary embodiment, the temperature control unit is a cooling unit, particularly a contact cooler. Additionally or alternatively, a temperature control unit may be provided which forms a furnace unit for heating the component.

In this regard, the metal blank is conveyed in the throughput direction along support rollers. The support rollers in particular extend transversely to the throughput direction and may, for example, be driven. The support rollers may, for example, have different coatings to reduce undesirable caking or other adhesion of contaminants. One or multiple support rollers may be driven to convey the metal blank in the throughput direction.

According to the present invention, centering units are provided which, for example, are present in front of a temperature control unit in the throughput direction (cold centering) or are arranged partially or completely in a temperature control chamber of the temperature control device, such as in the furnace chamber itself (hot centering). The centering unit has at least one centering finger which is movably arranged within the conveying plane. The centering finger may thus be used to move and position the metal blank in a predetermined orientation.

The centering finger is rod-shaped or designed as a pin-shaped element and extends from its bearing to the metal blank. In this regard, the centering finger may have a coupling region with which it may be coupled to a drive device, such as the guide unit mentioned below, and an opposite alignment region with which the centering finger may be coupled to an edge of the metal plate in order to move and align it in the conveying plane.

The conveying plane forms the plane in which the metal blank rests and within which the metal blank is moved in the throughput direction. The conveying plane has a perpendicular that runs perpendicular to the throughput direction and the transverse direction. The transverse direction is correspondingly aligned at a right angle to the throughput direction. In other words, the throughput direction and the transverse direction span the conveying plane.

In this regard, the centering finger may move the metal blank in a first direction, for example along the transverse direction, until the metal blank abuts against a stop and thus a defined alignment is given. In an embodiment described further below, a further centering finger may be arranged opposite the metal blank such that the metal blank may be clamped between two opposite centering fingers and aligned accordingly.

Alignment of the metal blank may be performed during continuous movement of the metal blank in the throughput direction by the centering fingers making short contact to align the metal blank. Alternatively, the metal blank may be conveyed sequentially in the throughput direction. Thus, to align the metal blank, the conveying motion may be stopped such that the metal blank is stationary. In a next step, the centering finger(s) may move to a predetermined position and thus align the metal blank in a desired orientation. After alignment, the metal blank may be conveyed further in the throughput direction in an aligned state. This ensures that the metal blank has assumed a predetermined position and/or orientation after the centering process. This in turn enables an exact and defined application of a temperature profile and/or a temperature pattern in a subsequent temperature control unit.

According to a further exemplary embodiment, the at least one centering finger is arranged between the two support rollers.

In the space between the two support rollers, the centering fingers can thus move transversely to the throughput direction, such that exact alignment is possible. Since the support rollers are spaced apart and the centering finger has a narrow geometry, the device according to the invention may be installed and retrofitted without changing the position of the support rollers.

According to another exemplary embodiment, the centering finger extends between a region above the conveying plane and below the conveying plane. In particular, there is usually sufficient installation space below the support rollers such that the drive units of the centering fingers may be installed there. From this lower region, the centering finger may project into the intermediate space (present in the throughput direction) between the support rollers into the upper region in order to adjust the metal blank.

According to another exemplary embodiment, the centering finger is arranged to be movable perpendicular to the conveying plane such that a free end of the centering finger may be moved between the region above the conveying plane and below the conveying plane. Thus, for example, the centering finger may only be moved into the upper region if centering or alignment of the metal blank is pending. In this regard, the centering finger may be configured to be retractable and extendable in a telescopic manner. Alternatively, the centering finger may be swiveled in and out.

According to another exemplary embodiment, the first centering unit comprises a guide unit which extends transversely to the throughput direction. The centering finger is coupled to the guide unit such that the centering finger is movable along the guide unit. The guide unit may, for example, have a rail or a unit with a corresponding guide groove. The centering finger itself may run within the guide groove or enclose the rail as a guide unit with a coupling element. Thus, a robust movement mechanism may be realized in which the centering finger is robustly guided along the transverse direction. In this regard, the guide unit may have a straight course or a curve-like course, such that a specific movement pattern of the centering finger may be specified.

According to another exemplary embodiment, the centering finger may be drivable along the guide unit by means of a linear motor. The linear motor may be, for example, an electric servomotor which drives the centering finger along the guide unit. In an exemplary embodiment, windings may be provided along the guide unit such that the guide unit is configured as a linear stator and the centering finger acts as a rotor of the linear motor and may be controlled accordingly in a targeted manner.

Alternatively, the centering finger may also be moved along the transverse direction by means of pneumatic or hydraulic drive mechanics. For example, hydraulic cylinders or pneumatic cylinders may be provided that can be selectively retracted and extended to move the centering finger in the transverse direction.

According to another exemplary embodiment, the device has a floor guide unit with a floor guide in the throughput direction and/or a further floor guide in the transverse direction. The floor guide unit may be arranged on a floor of a temperature control system, for example in front of or in a temperature control unit (e.g. furnace unit or cooling unit) of the temperature control system. In this case, the floor guide unit may be installed in front of or in the temperature control unit, in particular in a replaceable and correspondingly retrofittable manner. The floor guide in the throughput direction and/or the floor guide in the transverse direction may, for example, have corresponding guide rails or guide grooves along which the centering units may be guided accordingly in the throughput direction or transversely thereto and may be adjusted accordingly. Thus, the centering units may be flexibly adjusted to different sizes and shapes of the metal blank to be centered. For example, the centering units may be driven along the floor guides by means of a linear motor, which is arranged, for example, in the centering units and in the floor guide unit itself. A corresponding control unit may selectively control and adjust the centering units along the floor guides.

According to another exemplary embodiment, the centering finger comprises a fiber-reinforced material, in particular a fiber-reinforced ceramic, in particular comprising silicon carbide. Additionally or alternatively, a free end of the centering finger configured to align the metal blank may comprise a stainless steel material. Thus, the centering finger may be formed to be heat-resistant and robust, particularly in the region of contact with the metal blank. Thus, the centering finger may be formed in a filigree manner so that it can be embodied, for example, between small gaps, in particular between the support rollers.

According to a further exemplary embodiment, the first centering unit has at least one further centering finger which is arranged to be movable within the conveying plane such that the further centering finger may be moved transversely with respect to the throughput direction in order to align the metal blank in a predetermined orientation. The further centering finger is spaced from the centering finger transversely to the throughput direction such that the metal blank may be arranged between the centering finger and the further centering finger. The further centering finger may, for example, be arranged in the same guide unit as the centering finger described above and be movable along it. Alternatively, the further centering finger may have a separate guide unit in which is coupled.

According to a further exemplary embodiment, the device has a second centering unit with at least one centering finger, which is arranged to be movable within the conveying plane such that the centering finger may be moved transversely with respect to the throughput direction in order to align the metal blank in a further predetermined orientation. The second centering unit is arranged at a distance from the first centering unit in the throughput direction and/or transversely to the throughput direction. For example, the metal blank may be centered by a plurality of centering units with corresponding centering fingers which are spaced apart, in particular in the throughput direction.

Furthermore, multiple temperature control devices may be provided in the temperature control system. Thus, multiple metal blanks may be arranged in the transverse direction so that they may be simultaneously moved into a temperature control unit in the throughput direction and the temperature may be controlled at the same time. Each metal blank may be individually aligned by a corresponding device comprising the centering unit with corresponding centering fingers.

According to a further exemplary embodiment, the device has a stop bar which may be selectively moved into the conveying plane such that the metal blank may be moved against the stop bar in the throughput direction in order to stop a movement of the metal blank (at a desired position) in the throughput direction.

According to a further exemplary embodiment, the stop bar extends transversely to the throughput direction and is arranged between the support rollers.

According to a further exemplary embodiment, the stop bar is arranged being movable perpendicular to the conveying plane.

The stop bar may, for example, be moved translationally from the upper region or from the lower region into the conveying plane such that the metal blank abuts against the stop bar at a desired position. Furthermore, the stop bar may also be swiveled into the conveying plane.

In this case, the metal blanks may be conveyed sequentially through the furnace and stop at the location of centering. The position along the conveying direction is determined by the stop on the stop bar. The lateral alignment of the metal blank is determined by the centering fingers engaging and aligning the side edges of the metal blank. Alternatively, centering may also be performed with the stop bar in a continuous feed of the metal blank. For example, the stop bar is moved into the conveying plane so that the continuously fed metal blank moves against the stop bar. The support rollers continue to drive the metal blank, but conveyance along the direction of travel is prevented by the stop bar. The support rollers, so to speak, spin on the metal blank such that the metal blank remains in the centering position. The centering fingers may then be retracted laterally, i.e. transversely to the throughput direction, and align the metal blank. After alignment, the stop bar is moved out of the conveying plane so that the advance by the support rollers moves the metal blank on continuously, in the set alignment.

According to another exemplary embodiment, the stop bar comprises silicon carbide. This enables a high temperature resistance. At the same time, caking on the stop bar is reduced.

According to a further exemplary embodiment, the device comprises a detection unit, in particular an optical detection unit, which is configured to detect an orientation of the metal blank in the conveying plane. The detection unit may, for example, comprise a camera, for example a CCD camera, wherein an exact position and orientation of the metal blank may be determined via image analysis of the captured images. The centering finger is or the centering fingers are controllable based on the detection of an orientation of the metal blank such that by moving the centering finger the metal blank may be moved into a predetermined orientation within the conveying plane.

It should be noted that the presently described embodiments merely represent a limited selection of possible embodiment variants of the invention. Thus, it is possible to combine the features of individual embodiments in a suitable manner, so that for the person skilled in the art, a plurality of different embodiments are to be regarded as obviously disclosed with the embodiment variants made explicit herein. In particular, some embodiments of the invention are described by device claims and other embodiments of the invention are described by method claims. However, it will immediately become clear to the person skilled in the art upon reading this application that, unless explicitly stated otherwise, in addition to a combination of features belonging to one type of subject matter of the invention, any combination of features belonging to different types of subject matters of the invention is also possible.

### BRIEF DESCRIPTION OF THE DRAWINGS

Below, for further explanation and better understanding of the present invention, exemplary embodiments will be described in further detail making reference to the enclosed drawings.

FIG. 1 shows a schematic representation of a device for aligning a metal blank for a temperature control system according to an exemplary embodiment of the present invention.

FIG. 2 shows a schematic representation of a temperature control system with different temperature control devices according to an exemplary embodiment of the present invention.

FIG. 3 shows a schematic representation of a stop bar of the alignment device according to an exemplary embodiment of the present invention.

### DETAILED DESCRIPTION OF EXEMPLARY EMBODIMENTS

Equal or similar components are provided with equal reference numbers in different figures. The representations in the figures are schematic.

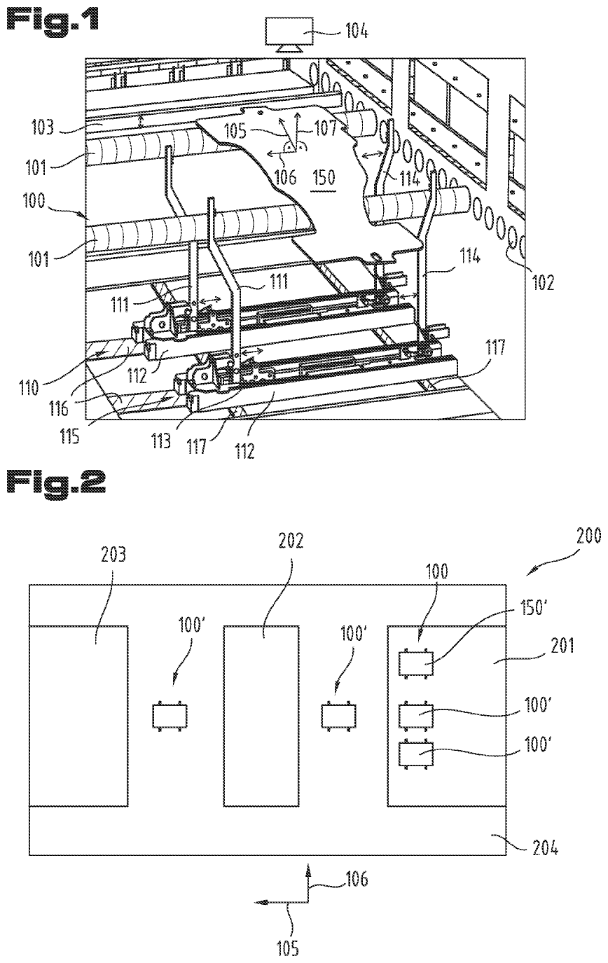

FIG. 1 shows a device 100 for aligning a metal blank 150 for a temperature control system 200. The device 100 comprises at least two support rollers 101 on which the metal blank 150 can be placed and conveyed through the temperature control system 200 by rotation of the support rollers 101 in the throughput direction 105 and within a conveying plane 204, wherein the support rollers 101 are arranged being spaced apart in the throughput direction 105. Furthermore, the device 100 comprises a first centering unit 110 having at least one centering finger 111 which is movably arranged within the conveying 204 plane such that the centering finger 111 is movable transversely to the throughput direction 105 in order to align the metal blank 150 in a predetermined orientation.

The metal blank 150 may, for example, have a homogeneous rectangular, round or elliptical shape. In practice, metal blanks 150 often have complex shapes. As shown in FIG. 1, for example, metal blanks 150 form corresponding stamped or otherwise cut metal plates that have complex outlines. In this regard, it is desirable for the temperature of different areas of the metal blank 150 to be controlled differently in a temperature control unit.

In this regard, the metal blank 150 is conveyed in the throughput direction along support rollers 101. The support rollers 101 in particular extend transversely (in the transverse direction 106) to the throughput direction 105 and may, for example, be driven. In this regard, the support rollers 101 are arranged being rotatable in corresponding bearing openings 102, which are, for example, provided in a housing of the device 100 and/or in a housing of the temperature control system 200 (see FIG. 2). FIG. 1 merely shows two support rollers 101 for the sake of better overview. However, corresponding support rollers 101 may also be provided in all or in most of the bearing openings 102.

In this regard, the centering unit 110 comprises two centering fingers 111, 114, which are opposite each other in the transverse direction 106 with respect to the metal blank 150 and are arranged so as to be movable within the conveying plane 204 (see FIG. 2). The centering finger 111 may thus be used to move and position the metal blank 150 in a predetermined orientation, in particular in the transverse direction 106.

The centering finger 111 is configured to be rod-shaped and/or pin-shaped. The centering finger 111 may have a coupling region with which it may be coupled to a drive device, such as the guide unit 112 mentioned below, and an opposite alignment region with which the centering finger 111 may be coupled to an edge of the metal plate 150 in order to move and align it in the conveying plane 204.

The conveying plane 204 forms the plane in which the metal blank 150 rests and within which the metal blank 150 is moved in the throughput direction 105. The conveying plane 204 has a perpendicular 107 that runs perpendicular to the throughput direction 105 and the transverse direction 106. The transverse direction 106 is correspondingly aligned at a right angle to the throughput direction 105. In other words, the throughput direction 105 and the transverse direction 106 span the conveying plane 204.

In this regard, the centering finger 111 may move the metal blank 150 in a first direction, for example along the transverse direction 106, until the metal blank 150 abuts against a stop or the further centering finger 114, so that the metal blank 150 may be aligned between two opposing centering fingers 111, 114.

Alignment of the metal blank 150 may be performed during continuous movement of the metal blank 150 in the throughput direction 105 by the centering fingers 111, 114 making short contact to align the metal blank 150. Alternatively, the metal blank 150 may be conveyed sequentially in the throughput direction. Thus, to align the metal blank 150, the conveying motion is stopped such that the metal blank 150 is stationary. In a next step, the centering fingers 111, 114 may move to a predetermined position thus align the metal blank 150 in a desired orientation.

The centering fingers 111, 114 of a centering unit 110, 115 are in each case arranged between the two support rollers 101. In the space between the two support rollers 101, the centering fingers 111, 114 can thus move transversely to the throughput direction 105, such that exact alignment is possible. Since the support rollers 101 are spaced apart and the centering fingers 111, 114 may have a narrow geometry, the device 100 according to the invention may be installed and retrofitted without changing the position of the support rollers 101.

The centering finger 111 extends between a region above the conveying plane 204 and below the conveying plane 204. In particular, there is sufficient installation space below the support rollers 101 such that the drive units of the centering fingers 111, 114 may be installed there. From this lower region, the centering finger 111, 114 may project into the intermediate space between the support rollers 101 into the upper region in order to adjust the metal blank 150.

The centering units 110, 115 each have a guide unit 112 which extends transversely to the throughput direction 105. The centering finger 111 is coupled to the guide unit 112 such that the centering finger 111 is movable along the guide unit 112. In this regard, the centering finger 111 may itself run within a guide groove as a guide unit 112 or enclose a guide rail as a guide unit 112. Thus, a robust movement mechanism may be realized in which the centering finger 111 is robustly guided along the transverse direction 106.

Furthermore, the opposing centering fingers 114 may be supported in the same guide unit (for example, a guide rail or guide groove 112) as the centering fingers 111.

The centering finger 111 is drivable along the guide unit 112 by means of a linear motor 113. The linear motor 113 may be, for example, an electric servomotor which drives the centering finger 111 along the guide unit 112. In an exemplary embodiment, windings may be provided along the guide unit 112 such that the guide unit 112 is configured as a linear stator and the centering finger 111 acts as a rotor of the linear motor and may be controlled accordingly in a targeted manner.

The centering finger 111 may be formed in a thin and filigree manner so that it can be embodied, for example, between small gaps, in particular between the support rollers 101.

In this regard, the centering finger 111 and the opposite centering finger 114 may be formed such that in the lower region below the metal blank 150 the distance between the centering fingers 111, 114 in the transverse direction 106 is smaller than a distance between the centering fingers 111, 114 in the transverse direction 106 in the upper region above the metal blank 150. Thus, shorter guide units 112 may be provided in the lower region, while wider metal blank 150 in the transverse direction 106 may be aligned by the centering fingers 111, 114 in the upper region.

In the throughput direction 105, a further second centering unit 115 may be provided, which is spaced apart from the first centering unit 110 in the throughput direction 105. The second centering unit 115 also has two centering fingers 111, 114 opposite each other in the transverse direction 106, which is arranged within the conveying plane 204 such that it can be moved, in particular in the transverse direction 106, such that the centering fingers 111, 114 can be moved transversely with respect to the throughput direction 105 in order to align the metal blank 150 in a further predetermined orientation.

Furthermore, FIG. 1 shows a stop bar 103, which may be selectively moved into the conveying plane 204 such that the metal blank 150 moves against the stop bar 103 in the throughput direction 105 to stop a movement of the metal blank 150 (at a desired position) in the throughput direction 105.

The stop bar 103 extends transversely to the throughput direction 105 and is arranged, for example, between the support rollers 101. In particular, the stop bar 103 is translationally movable perpendicular to the conveying plane 204.

The position of the metal blank 150 is determined along the conveying direction 105 by the stop against the stop bar 103. The lateral alignment of the metal blank 150 is determined in the transverse direction 106 by the centering fingers 111, 114 engaging and aligning the side edges of the metal blank 150.

Furthermore, a detection unit 104, in particular an optical detection unit, may be provided which is configured for detecting an orientation of the metal blank 150 in the conveying plane. The centering fingers 111, 114 are controlled such based on the detection of an orientation of the metal blank 150 that these move the metal blank 150 into a predetermined orientation within the conveying plane 204.

In a floor in front of or in the temperature control unit, a floor guide unit is shown with a floor guide 116 in the throughput direction 105 and a further floor guide 117 in the transverse direction 106. The floor guide 116 in the throughput direction 105 and the floor guide 117 in the transverse direction 106 have intersecting guide rails along which the centering units 110, 115 may be guided accordingly in the throughput direction 105 or transversely thereto and may be adjusted accordingly.

For example, the centering units may be driven and controlled along the floor guides 116, 117 by means of a linear motor, which is arranged, for example, in the temperature control units 110, 115 and in the floor guide unit itself. A corresponding control unit may selectively control and adjust the centering units 110, 115 along the floor guides.

FIG. 2 shows a schematic representation of a temperature control system 200 with different temperature control devices 100, 100′, which may be configured according to the temperature control device 100 of FIG. 1 described in detail.

The temperature control system 200 has one or more temperature control units 201, 202, 203 which are arranged, for example, one after the other in the throughput direction 105. The temperature control units 201, 202, 203 may, for example, heat or specifically cool the metal blank 150. For example, the metal blank 150 first runs through a furnace 201 as the temperature control unit in the throughput direction 105. Subsequently, the blank, for example, runs through a temperature-controllable mill stand and/or a rolling device 202 as a temperature control unit. Subsequently, the metal blank 150 may again run through a further furnace 203 as a temperature control unit. Accordingly, the metal blank 150 may subsequently also run through cooling device (for example contact coolers) as temperature control devices.

In this regard, the metal blank 150 may be conveyed continuously through a temperature control unit 201, 202, 203 or placed sequentially at predetermined positions within the temperature control units 201, 202, 203 and subjected to stationary heat treatment before further transport along the throughput direction 105 is performed. In this regard, the temperature control units 201, 202, 203 may heat or cool specific areas of the metal blank 150 differently. Thus, a predetermined heat pattern or cooling pattern may be applied to the metal blank 150, provided that the metal blanks 150 are aligned in a predetermined orientation.

As is shown in FIG. 2, it is also possible that multiple devices 100, 100′ for aligning corresponding metal blanks 150 may be provided in the transverse direction 106. Furthermore, a device 100 for aligning corresponding metal blanks 150 may be arranged one after the other in the throughput direction 105. Furthermore, a device 100 for aligning corresponding metal blanks 150 in a temperature control unit 201, such as a furnace, may be provided. Thus, hot centering, i.e., centering of the metal blank 150 in the temperature-controlled state, may be performed. Likewise, a device 100 for aligning corresponding metal blanks 150 may be provided outside the temperature control units 201, 202, 203, such that the device 100 is not fully exposed to the temperatures in a temperature control unit 201, 202, 203. Thus, cold centering may be performed.

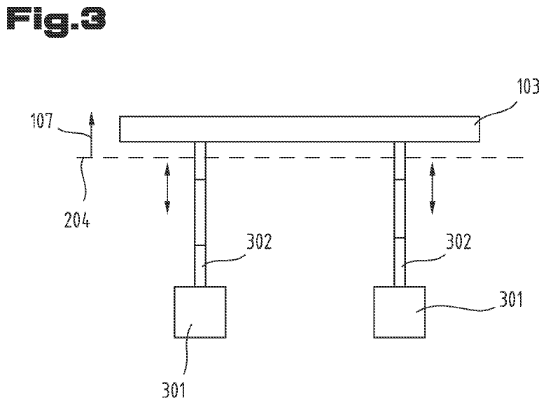

FIG. 3 shows a schematic representation of a stop bar 103 of the alignment device 100 according to an exemplary embodiment of the present invention. The stop bar 103 is selectively movable into the conveying plane 204 (see FIG. 2) such that the metal blank 150 moves against the stop bar 103 in the throughput direction 105 to stop a movement of the metal blank 150 (at a desired position) in the throughput direction 105.

In particular, the stop bar 103 is controlled by drive units 301. Appropriate control connections 302 may be provided between the drive units 301 and the stop bar 103. For example, the control connections 302 may represent telescopically retractable and extendable rod elements. For example, the control connections 302 may be swivelably provided on the drive units 301 and the stop bar 103 such that the stop bar 103 may be placed above and below the conveying plane 204 by means of swiveling.

For example, the drive units 301 may be configured as linear motors in order to move the stop bar 103. Furthermore, the drive units 301 may be configured as pneumatic, hydraulic or electromechanical drives. For example, the control connections 302 may be hydraulically, pneumatically, or electromechanically retractable, extendable, or swivelable.

Additionally, it should be noted that “comprising” does not preclude other elements or steps, and “one” or “a” does not preclude a plurality. Moreover, it should be noted that features or steps that have been described with reference to one of the above exemplary embodiments may also be used in combination with other features or steps of other exemplary embodiments described above. Reference numbers in the claims are not to be regarded as a limitation.

### LIST OF REFERENCE NUMBERS

100 Alignment device
101 Support roller
102 Bearing opening for support roller
103 Stop bar
104 Detection unit
105 Throughput direction
106 Transverse direction
107 Perpendicular of the conveying plane
110 First centering unit
111 Centering finger
112 Guide unit
113 Linear motor
114 Further centering finger
115 Second centering unit
116 Floor guide in throughput direction
117 Floor guide in transverse direction
150 Metal blank
200 Temperature control system
201 Temperature control unit/furnace
202 Temperature control unit/mill stand
203 Temperature control unit/further furnace
204 Conveying plane
301 Drive unit
302 Control connection

1. A device (100) for aligning a metal blank (150) for a temperature control system (200), which comprises at least one temperature control unit (201, 202, 203) for heating or cooling the metal blank (150), the device (100) comprising
at least two support rollers (101) on which the metal blank (150) is placeable and conveyable through the temperature control system (200) by rotation of the support rollers (101) in the throughput direction (105) and within a conveying plane (204), wherein the support rollers (101) are spaced apart in the throughput direction (105),
a first centering unit (110) having at least one centering finger (111) which is movably arranged within the conveying plane (204) such that the centering finger (111) is movable transversely to the throughput direction (105) in order to align the metal blank (150), which is placeable on the support rollers (101), in a predetermined orientation, and
a second centering unit (115) with at least one centering finger (111) which is movably arranged within the conveying plane (204) such that the centering finger (111) is movable transversely to the throughput direction (105) in order to align the metal blank (150) in a further predetermined orientation,
wherein the second centering unit (115) is arranged at a distance from the first centering unit (110) in the throughput direction (105) and/or transversely to the throughput direction (105),
wherein, in a floor in front of or in the temperature control unit (201, 202, 203), a floor guide unit with a floor guide (116) is arranged in the throughput direction (105) and a further floor guide (117) is arranged in the transverse direction (106),
wherein the floor guide (116) in the throughput direction (105) and the further floor guide (117) in the transverse direction (106) have intersecting guide rails along which the centering unit (110) and the further centering unit (115) may be guided accordingly in the throughput direction (105) or transversely thereto and may be adjusted accordingly.

2. The device (100) according to claim 1,
wherein the at least two support rollers (101) extend transversely to the throughput direction (105).

3. The device (100) according to claim 1, wherein the centering finger (111) is arranged between the two support rollers (101).

4. The device (100) according to claim 1, wherein the centering finger (111) extends between a region above the conveying plane (204) and below the conveying plane (204).

5. The device (100) according to claim 4, wherein the centering finger (111) is arranged to be movable perpendicular to the conveying plane (204) such that a free end of the centering finger (111) is movable between the region above the conveying plane (204) and below the conveying plane (204).

6. The device (100) according to claim 1,
wherein the first centering unit (110) comprises a guide unit (112) which extends transversely to the throughput direction (105), and
wherein the centering finger (111) is coupled to the guide unit (112) such that the centering finger (111) is movable along the guide unit (112).

7. The device (100) according to claim 6, wherein the centering finger (111) is drivable along the guide unit (112) by means of a linear motor (113).

8. The device (100) according to claim 1, further comprising
a floor guide unit with a floor guide (116) in the throughput direction (105) and/or a further floor guide (117) in the transverse direction (106).

9. The device (100) according to claim 1,
wherein the centering finger (111) comprises a fiber-reinforced material, in particular a fiber-reinforced ceramic, in particular comprising silicon carbide, and/or
wherein a free end of the centering finger (111) configured to align the metal blank (150) comprises a stainless steel material.

10. The device (100) according to claim 1,
wherein the first centering unit (110) comprises at least one further centering finger (114) which is movably arranged within the conveying (204) plane such that the further centering finger (114) is movable transversely to the throughput direction (105) in order to align the metal blank (150) in a predetermined orientation, and
wherein the further centering finger (114) is spaced from the centering finger (111) transversely to the throughput direction (105) such that the metal blank (150) is arrangeable between the centering finger (111) and the further centering finger (114).

11. (canceled)

12. The device (100) according to claim 1, wherein at least one of the support rollers (101) for conveying the metal blank (150) is drivable in the throughput direction (105).

13. The device (100) according to claim 1, further comprising
a stop bar (103), which may be selectively moved into the conveying plane (204) such that the metal blank (150) is movable against the stop bar (103) in the throughput direction (105) to stop a movement of the metal blank (150) in the throughput direction (105).

14. The device (100) according to claim 12, wherein the stop bar (103) extends transversely to the throughput direction (105) and is arranged between the support rollers (101).

15. The device (100) according to claim 13, wherein the stop bar (103) is arranged to be movable perpendicular to the conveying plane (204).

16. The device (100) according to claim 13, wherein the stop bar (103) comprises silicon carbide.

17. The device (100) according to claim 1, further comprising
a detection unit (104), in particular an optical detection unit (104), which is configured for detecting an orientation of the metal blank (150) in the conveying plane (204),
wherein the centering finger (111) is controllable based on the detection of an orientation of the metal blank (150) such that by moving the centering finger (111) the metal blank (150) may be moved into a predetermined orientation within the conveying plane (204).

18. A temperature control system (200) for controlling the temperature of a metal blank (150), the temperature control system (200) comprising
at least one temperature control unit (201, 202, 203),
the device (100) for aligning a metal blank (150) according to claim 1,
wherein the device (100) is arranged in front of or in the temperature control unit (201, 202, 203) in the throughput direction (105) such that the metal blank (150) is alignable in front of or at least partially in the temperature control unit (201, 202, 203).

19. The temperature control system (200) according to claim 18,
wherein the temperature control unit (201, 202, 203) is a cooling unit, in particular a contact cooler, and/or
wherein the temperature control unit (201, 202, 203) is a furnace unit.

20. A method for aligning a metal blank (150) for a temperature control system (200), which comprises at least one temperature control unit (201, 202, 203) for heating or cooling the metal blank (150), the method comprising
conveying the metal blank (150) within a conveying plane (204) through the temperature control system (200) by means of at least two support rollers (101) on which the metal blank (150) rests and is conveyed in the throughput direction (105) by means of rotation of the support rollers (101), and
wherein the support rollers (101) are spaced apart in the throughput direction (105),
aligning the metal blank (150) into a predetermined orientation by means of a first centering unit (110) having at least one centering finger (111) which is movably arranged within the conveying plane (204) such that the centering finger (111) is movable transversely to the throughput direction (105) and with a second centering unit (115) with at least one centering finger (111) which is movably arranged within the conveying plane (204) such that the centering finger (111) is movable transversely to the throughput direction (105) in order to align the metal blank (150) in a further predetermined orientation, wherein the second centering unit (115) is arranged at a distance from the first centering unit (110) in the throughput direction (105) and/or transversely to the throughput direction (105),
wherein, in a floor in front of or in the temperature control unit (201, 202, 203), a floor guide unit with a floor guide (116) is arranged in the throughput direction (105) and a further floor guide (117) is arranged in the transverse direction (106),
wherein the floor guide (116) in the throughput direction (105) and the further floor guide (117) in the transverse direction (106) have intersecting guide rails along which the centering unit (110) and the further centering unit (115) are guided accordingly in the throughput direction (105) or transversely thereto and are adjusted accordingly.
